(19) United States
(12) Patent Application Publication
(10) Pub. No.: US 2008/0303285 A1
(43) Pub. Date: Dec. 11, 2008

(54) METHOD AND APPARATUS FOR HYDROELECTRIC POWER GENERATION

(76) Inventor: Troy D. Bondhus, Monticello, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/137,299

(22) Filed: Jun. 11, 2008

Related U.S. Application Data
(60) Provisional application No. 60/934,036, filed on Jun. 11, 2007.

(51) Int. Cl. F03B 9/00

(52) U.S. Cl. 290/54

(57) ABSTRACT

A hydroelectric generation device utilizing a series of parachutes below the surface of a flowing body of water for imparting rotational energy to a generator assembly. The hydroelectric generation device can include a positioning assembly for positioning and retaining the hydroelectric generation device below a water surface. The generator assembly generally includes a generator positioned on a water bed for producing electricity from a rotation input to the generator and a transmission line for transmitting the electricity for use on shore. The parachutes are attached to a cable loop which interfaces with an axle assembly for transferring rotational energy to the generator assembly.

### PRIORITY CLAIM

The present application claims priority to U.S. Provisional Application Ser. No. 60/934,036, filed Jun. 11, 2007 and entitled, “METHOD AND APPARATUS FOR HYDROELECTRIC POWER GENERATION, which is herein incorporated by reference in its entirety.

### FIELD OF THE INVENTION

The present invention is generally directed to the field of hydroelectric power generation. More specifically, the present invention is directed to an apparatus and method for harnessing water flow with a minimum of infrastructure and disturbance to a water source.

### BACKGROUND OF THE INVENTION

The concept of harnessing energy from natural water flow has been practiced for centuries. These concepts can range from the relatively simple such as, for example, a water or paddle wheel for powering flour and lumber mills, all the way to large scale municipal projects involving the construction of dams and other structures to funnel water through turbines. Regardless of design, the general principle involves converting water flow, albeit gravity or tidal driven flow, as an energy source.

In more recent advancements, a variety of improved paddlewheel style designs have been suggested for generating electricity from water power. Examples of paddlewheel style designs include U.S. Pat. Nos. 4,104,536 to Gutsfeld, 5,844,323 to Hung and 6,006,518 to Geary, each of which is herein incorporated by reference.

Alternatively, a variety of rotary generation devices utilizing a propeller or turbine style blades have been contemplated for the generation of hydroelectric power. Representative examples include U.S. Pat. Nos. 3,928,771 to Straumsnes and 3,984,698 to Brewer.

In addition a, a variety of alternative designs utilizing belts, cables and/or chains in place of a wheel assembly have also been contemplated for generating electricity from water power. Example of these designs include U.S. Pat. Nos. 3,887,817 to Steelman, 3,927,330 to Skorupinski, 5,684,335 to Ou and 6,809,430 to Diedrich.

While these prior patents, all of which are herein incorporated by reference in their entirety, have suggested various improvements to hydroelectric generation devices, there remains a need to identify improved designs that have a minimum of capital cost while maximizing system flexibility.

### SUMMARY OF THE INVENTION

A hydroelectric generation device of the present invention requires minimal infrastructure and can be utilized in remote locations in which prior art devices are impractical. Generally, a representative embodiment of a hydroelectric generation device can comprise a positioning assembly, a generator assembly and a water interface assembly. The positioning assembly allows the hydroelectric generating device to be positioned and retained below the surface of a body of flowing water such as, for example, a river, stream or tidal basin. The generator assembly generally comprises a generator positioned on a water bed for producing electricity from a rotation input to the generator and a transmission line for transmitting the electricity for use on shore. The water interface assembly generally includes an axle assembly, a cable loop and a plurality of parachutes wherein the parachutes deploy in response to the flow of water whereby the cable loop is directed around the axle assembly such that rotational motion is created and transferred to the generator assembly.

In one aspect, the present disclosure is related to a hydroelectric energy system in which parachutes deployed below the surface of a flowing body of water are utilized to generate rotation energy which can be converted to electrical energy in an attached generator assembly. The hydroelectric energy system can be maintained below the surface of the body of water using an anchor assembly positioned on a water bed. Each parachute can include an upper portion and a lower portion which are maintained in relation using a series of floats and sinkers attached to the related parachute portion. By maintaining the orientation of the upper and lower portions of the parachutes, twisting and tangling of the upper and lower portions is eliminated. Furthermore, the floats and sinkers promote stability and efficiency of the parachutes which in some case can allow the parachutes to open earlier.

In another aspect, the present disclosure is directed to a method of generating hydroelectric power using a plurality of parachutes to capture water energy and translate said water energy to a generating device. The parachutes can be positioned below a surface of a flowing body of water so as to prevent disruption to surface traffic and prevent encounters with floating debris.

In yet another aspect of the present disclosure, a system for generating hydroelectric power from a flowing body of water can comprise a cable loop having a plurality of parachute members capable of interfacing with a water flow. When in a deployed orientation, the parachute members provide rotational motion to the cable loop which in turn provides a rotational input to a generating device such that electrical energy can be generated. The electrical energy can be transmitted for use on shore with a suitable transmission line.

As used throughout the present specification, the terms “upper” and “lower” are intended to provide reference points for the various elements in which “upper” refers to a direction nearest a surface of a water body while “lower” refers to a direction nearest a bed or bottom of the water body.

The above summary of the invention is not intended to describe each illustrated embodiment or every implementation of the present invention. The Figures and the detailed description that follow more particularly exemplify these embodiments.

### BRIEF DESCRIPTION OF THE FIGURES

The invention may be more completely understood in consideration of the following detailed description of various embodiments of the invention in connection with the accompanying drawings, in which:

FIG. 1 is a side view of a hydroelectric power generation system according to an embodiment of the present disclosure.

FIG. 2 is a top view of the hydroelectric power generation system of FIG. 1.

FIG. 3 is a side view of the hydroelectric power generation system of FIG. 1.

FIG. 4 is an end view of an embodiment of a parachute for use with the hydroelectric power generation system of FIG. 1.

FIG. 5 is a side view of an axle assembly according to an embodiment of the present disclosure.

FIG. 6 is a top view of the axle assembly of FIG. 5 interfacing with an embodiment of a cable loop according to the present disclosure.

FIG. 7 is a top view of an embodiment of an axle assembly interfacing with an embodiment of a cable loop according to the present disclosure.

FIG. 8 is a side view of the axle assembly and cable loop of FIG. 7.

FIG. 9 is a side view of a cable loop according to an embodiment of the present disclosure.

FIG. 10 is a side view of a pair of sheets being joined to form the cable loop of FIG. 9.

FIG. 11 is a side view of the pair of sheets of FIG. 10 joined to form the cable loop of FIG. 9.

FIG. 12 is a top view of a hydroelectric power generation system according to an embodiment of the present disclosure.

FIG. 13 is a side view of an optional stabilizer assembly utilized with the hydroelectric power generation system of FIG. 12.

FIG. 14 is a top view of the optional stabilizer assembly of FIG. 13.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE FIGURES

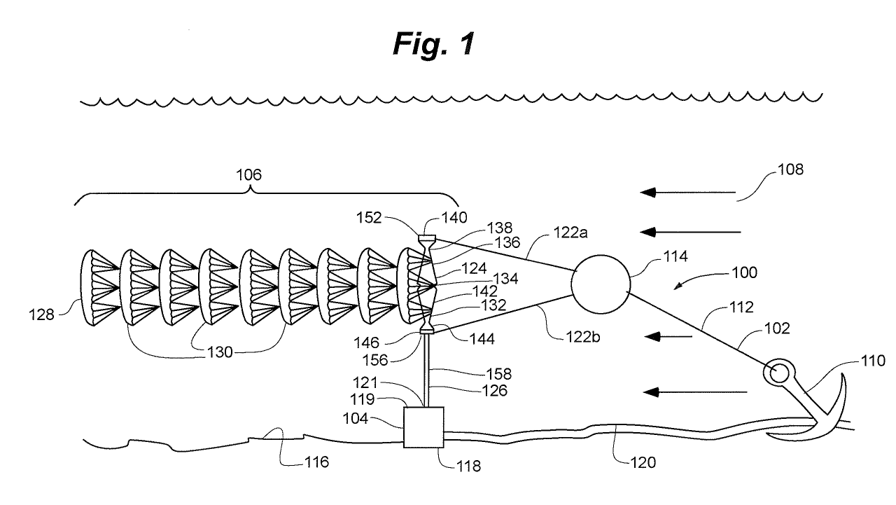

As illustrated in FIG. 1, a representative embodiment of a hydroelectric generating device 100 can comprise a positioning assembly 102, a generator assembly 104 and a water interface assembly 106. Hydroelectric generating device 100 is generally positioned below the surface of a body of flowing water 108 such as, for example, a river, stream or tidal basin. In a preferred embodiment, hydroelectric generating device 100 can be located at a depth of at least about 25 feet and more preferably, at least about 50 feet below the surface of flowing water 108 so as to avoid boat traffic and/or debris present at the surface.

Referring again to FIG. 1, positioning assembly 102 generally comprises an anchor member 110, an anchor line 112 and a float member 114. Depending upon the nature of hydroelectric generating device 100, anchor member 110 can comprise a movable anchor member such as, for example, a conventional boat anchor design. Alternatively, anchor member 110 can comprise a more permanent mounting structure such as, for example, a piling driven into or otherwise positioned in a water bed 116. Anchor line 112 generally comprises a length of chain or cable that operably connects the anchor member 110 and float member 114. Float member 114 generally comprises a buoyant object fabricated of a buoyant material or containing a gas such as, for example, air, nitrogen and the like. Float member 114 is generally sized based on a number of factors including, for example, rate of water flow and overall generating capacity of hydroelectric generating device 100 in terms of physical size and power generation capacity.

Generator assembly 104 generally comprises an airtight generator 118 and a power transmission line 120 as shown in FIG. 1. Airtight generator 118 generally comprises an access surface 119 including an access bore 121. Airtight generator 118 generally is of a size large enough such that the rate of water flow does not effect and/or changed the position of airtight generator 118 on the water bed 116. Power transmission line 120 generally comprises an insulated line that interconnects the airtight generator 118 with a power interface located on the shore of the body of flowing water 108. The power interface can include a connection to a power grid, a battery storage device and the like.

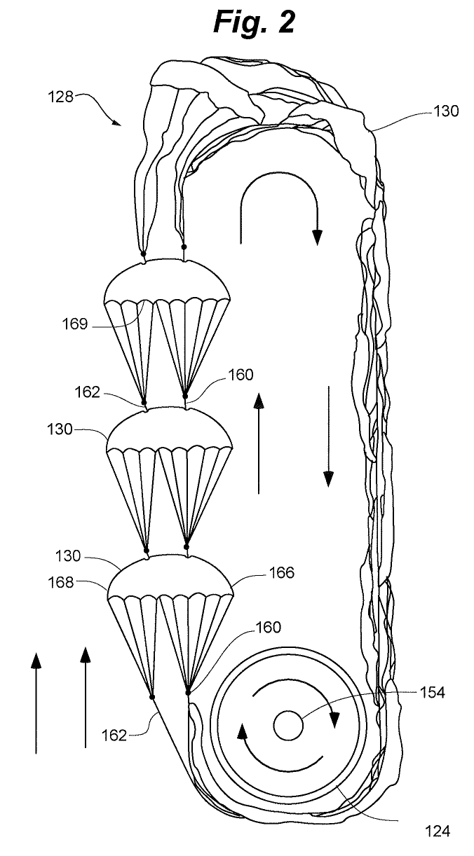

As illustrated in FIGS. 1 and 2, water interface assembly 106 generally comprises a pair of retention members 122a, 122b, an axle assembly 124, a shaft assembly 126, a cable loop 128 and a plurality of parachute members 130. Axle assembly 124 generally comprises an axle body 132 having a retention groove 134, an upper tapered surface 136, an upper retention groove 138, an upper end member 140, a lower tapered surface 142, a lower retention groove 144 and a lower end member 146. Upper end member 140 and lower end member 146 each comprise a mounting bore 148 for operably coupling the shaft assembly 126 through a center axis 150 of the axle body 132. Shaft assembly 124 generally comprises an upper bearing assembly 152, an upper shaft member 154, a lower bearing assembly 156 and a lower shaft member 158. Upper shaft member 154 is generally within the axle body 132 and extends between mounting bores 148 on the upper end member 140 and lower end member 146. Upper shaft member 154 is operably connected to lower shaft member 158 at lower bearing assembly 156 such that rotational energy imparted upon the upper shaft member 154 can be transmitted to the airtight generator 118 using lower shaft member 158 mounted through access bore 124. In some embodiments, lower bearing assembly 156 can comprise a gear reducer or multiplier to adjust the rotational speed of the lower shaft member 158 in comparison to the upper shaft member 154.

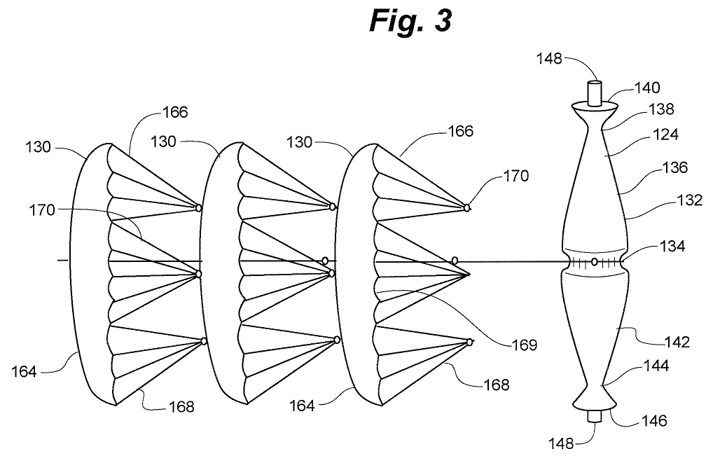

Referring to FIGS. 2, 3 and 4, cable loop 128 generally comprises a center line 160 and one or more exterior lines 162. Each parachute member 130 generally comprises a canopy 164 having at least an upper canopy portion 166, a lower canopy portion 168 and a deployment surface 169. In some embodiments, parachute member 130 can comprise one or more central canopy portions 170. Each canopy portion, regardless of upper, lower or central positions, generally includes a plurality of perimeter connection points 172 and a central aperture 174. Perimeter connection points 172 on the upper canopy portion 166 include an upper float assembly 176 while the perimeter connection points 172 on the lower canopy portion 168 include a lower sinker assembly 178. Parachute member 130 further includes a cable connection 180 located generally intermediate the upper canopy portion 166 and lower canopy portion 168. In some embodiments, the components of each parachute member 130, for example, the upper canopy portion 166, lower canopy portion 168 and deployment surface 169 can be located on an exterior side of the cable loop 128 so as to avoid contact between the canopy 164 and the axle body 132 so as to avoid wear and tear on the parachute members 130.

Hydroelectric generating device 100 is used to generate electricity as shown generally in FIGS. 1 and 4. Generally, a site is selected for placement of the hydroelectric generating device 100 and anchor member 110 is positioned on the water bed 116 at an upstream side of the site. Water flow causes the float member 114 to move to a downstream position until the anchor line 112 pulls tight. At this point, water interface assembly 106 continues downstream until retention members 122a, 122b are tight. When retention members 122a, 122b are pulled tight, axle body 132 is positioned in a substantially vertical orientation with respect to water bed 116. Cable loop 128 and parachute members 130 continue downstream until cable loop 128 is pulled tight around axle body 132.

As cable loop 128 pulls tight, parachute members 130 having deployment surface 129 facing upstream begin to expand and deploy as shown in FIGS. 1 and 4. At the same time, parachute members 130 having deployment surface 129 facing downstream are contracted. The deployed parachute members 130 fill with water causing cable loop 128 to turn around axle body 132. As axle body 132 spins, the rotational motion is transferred from the upper shaft member 154 to the lower shaft member 158. Lower shaft member 158 interfaces with the airtight generator 118 causing electricity to be generated which is then transmitted for use on shore by power transmission line 120.

As cable loop 128 rotates around axle assembly 124, the profile of axle body 132 prevents tangling of the parachutes 130, center line 160 and exterior lines 162. Center line 160 is maintained within retention groove 134 while the upper canopy portion 166 is maintained along the upper tapered surface 136 and upper retention groove 138 while the lower canopy portion 168 is maintained along the lower tapered surface 142 and lower retention groove 144. In addition, upper float assemblies 176 and lower sinker assemblies 178 assist in maintaining separation and preventing tangling of the upper canopy portion 166 and lower canopy portion 168.

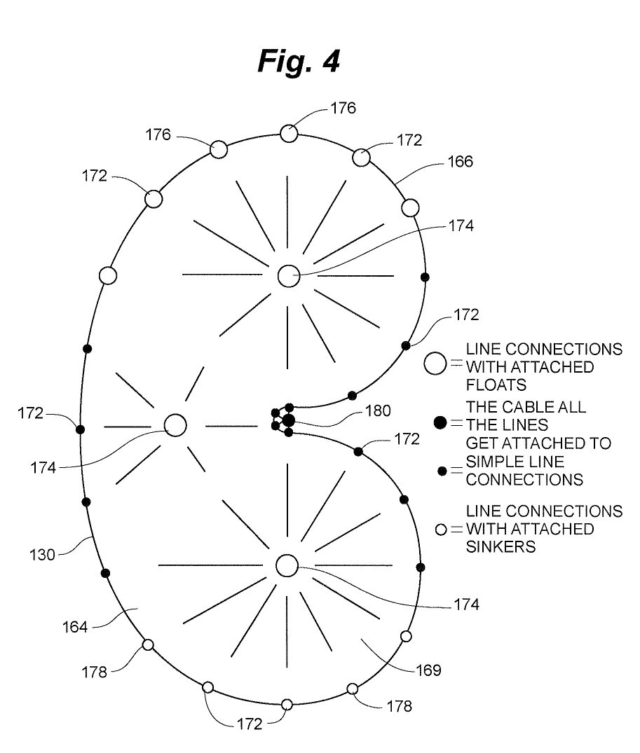

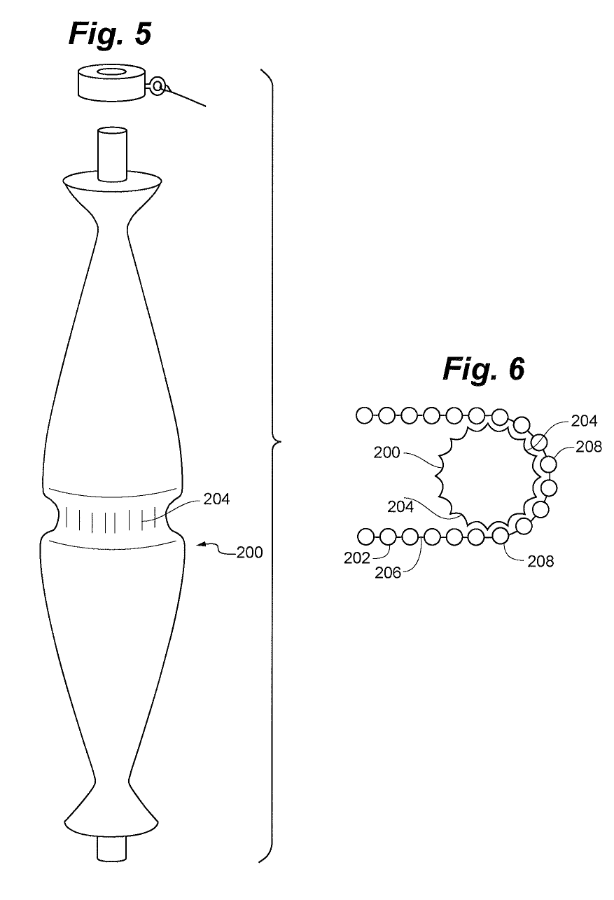

Referring to FIGS. 5 and 6, an alternative embodiment of an axle assembly 200 can be utilized with a segmented cable loop 202. Axle assembly 200 can substantially resemble axle assembly 124 with the further inclusion of a notched retention groove 204. Segmented cable loop 202 can comprise a cable 206 having a plurality of evenly spaced projecting members 208 such as, for example, knots and the like, that are sized and spaced to interface with the notched retention groove 204. Through physical engagement of the notched retention groove 204 and projecting members 208, slippage between axle assembly 200 and the segmented cable loop 202 can be avoided so as to further increase energy transfer and increase overall efficiency.

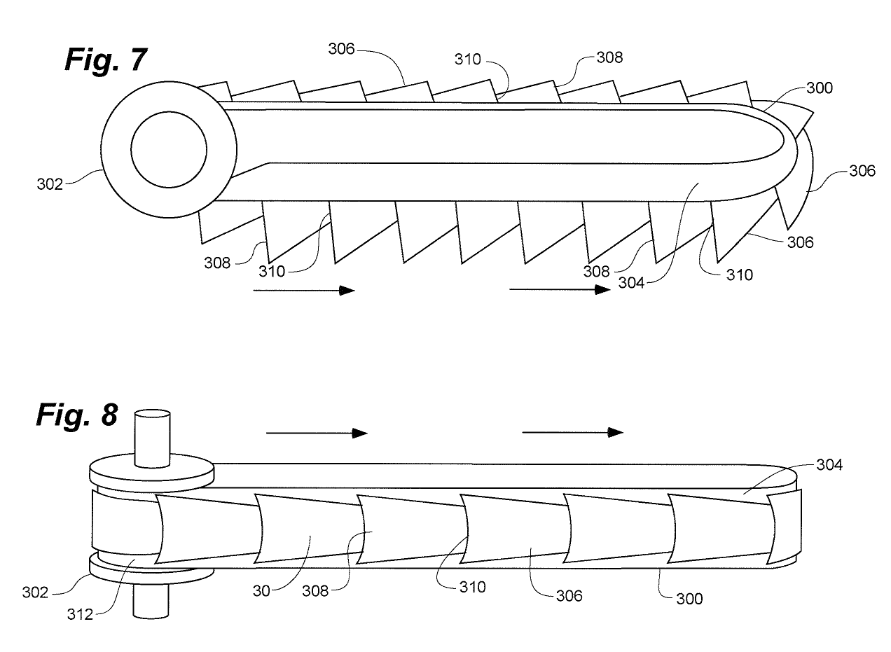

Referring to FIGS. 7 and 8, an alternative embodiment of a cable loop 300 can be utilized with an axle assembly 302. Cable loop 300 can comprise a continuous belt 304 having a plurality of pocket members 306. Each pocket member 306 has a generally enlarged open end 308 and a reduced closed end 310. Axle assembly 302 generally comprises a consistent radius body 312 sized to engage continuous belt 304. When placed in a body of water, current causes the pocket member 306 to open when enlarged open end 308 faces upstream and to close when reduced closed end 310 faces upstream. By capturing water within the pocket member 306, cable loop 306 causes axle assembly 302 to rotate and generate rotational energy for transmission to the airtight generator 118.

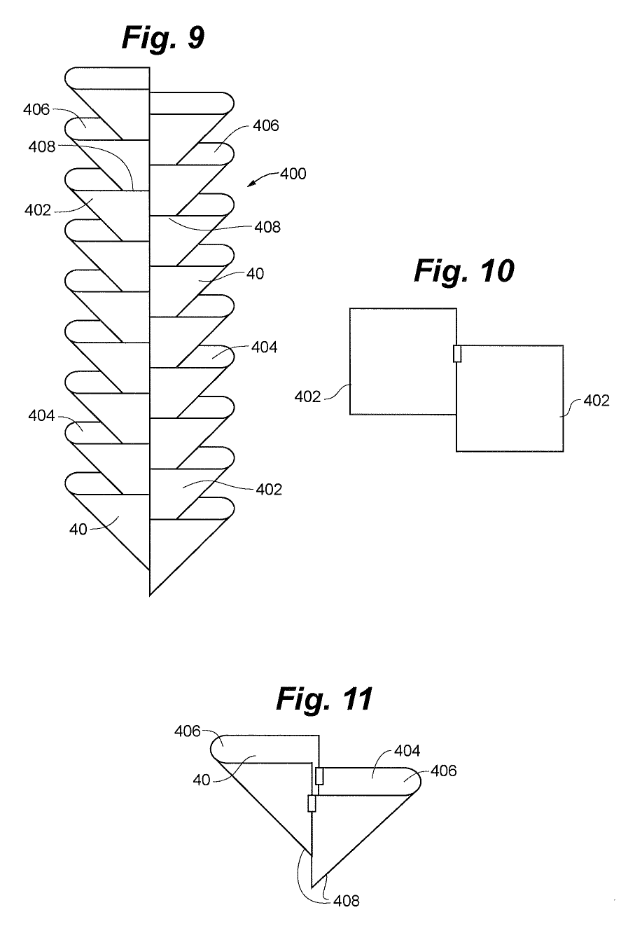

Referring to FIGS. 9, 10 and 11, an alternative embodiment of a cable loop 400 can be utilized with axle assembly 302. Cable loop 400 can comprise a plurality of sheets 402 that are staggered and joined together to form a series of alternating pockets 404. Each pocket 404 is defined by an enlarged open end 406 and a reduced closed end 408. When placed in a body of water, current causes the alternating pockets 404 to open when enlarged open end 406 faces upstream and to close when reduced closed end 408 faces upstream. By capturing water within the alternating pockets 404, cable loop 400 causes axle assembly 302 to rotate and generate rotational energy for transmission to the airtight generator 118.

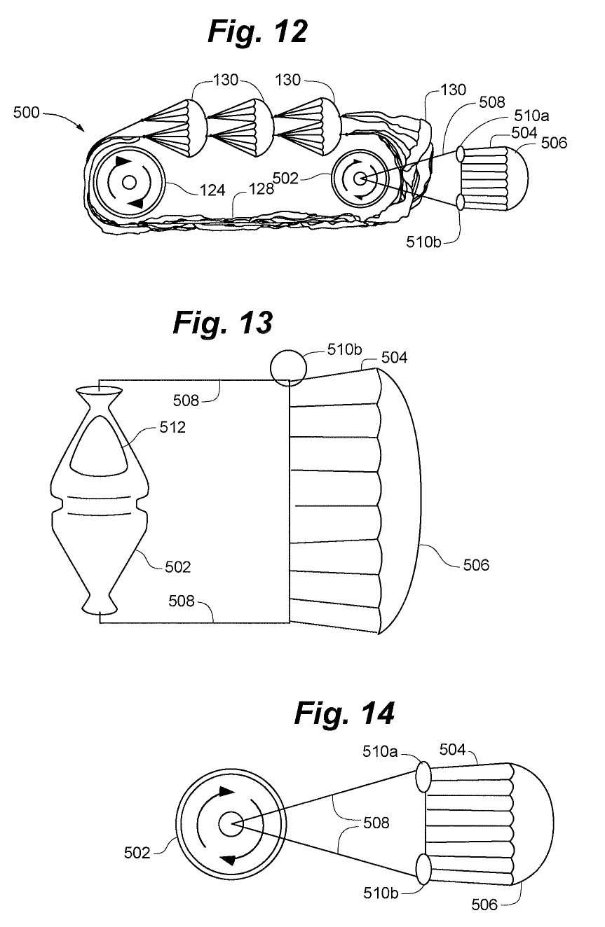

Referring to FIGS. 12, 13 and 14, another alternative embodiment of a hydroelectric generating device 500 can substantially resemble hydroelectric generating device 100 with the further inclusion of a second axle assembly 502 positioned downstream of the first axle assembly 124. Second axle assembly 502 can be fabricated to include substantially the same profile as axle body 132. A downstream positioning assembly 504 can be attached to the second axle assembly 502 to keep cable loop 128 taut and increase overall efficiency of the hydroelectric generating device 500. Downstream positioning assembly 504 can include a positioning parachute 506 attached to the second axle assembly 502 by means of a cable 508, chain or the like. Positioning parachute 506 can include one or more positioning float assemblies 510a, 510b to maintain the vertical orientation and deployment of the positioning parachute 506 relative to the second axle assembly 502. In some embodiments, second axle assembly 502 can include an internal float assembly 512 to assist in maintaining a proper vertical orientation of the second axle assembly 502. The use of second axle assembly 502 can also help to prevent tangling of the cable loop 128 and the associated parachute members 130 by maintaining adequate spacing and tension downstream of the first axle assembly 124.

Although specific examples have been illustrated and described herein, it will be appreciated by those of ordinary skill in the art that any arrangement calculated to achieve the same purpose could be substituted for the specific example shown. This application is intended to cover adaptations or variations of the present subject matter. Therefore, it is intended that the invention be defined by the attached claims and their legal equivalents.

What is claimed is:

1. A method for generating hydroelectric power, comprising:
providing a hydroelectric generating device comprising a positioning assembly, a generator assembly and water interface assembly;
placing the hydroelectric device below the surface of a water body having a water flow, wherein the positioning assembly;
maintaining the position of hydroelectric device relative to the water body;
engaging the water flow with a plurality of deformable engagement members on the water interface assembly to provide a rotational input to the generator assembly; and
converting the rotational input to electricity within the generator assembly.

2. The method of claim 1, further comprising:
transmitting the generated electricity to shore.

3. The method of claim 1, wherein maintaining the position of the hydroelectric device comprises affixing the positioning assembly to a lower surface of the water body.

4. The method of claim 3, wherein maintaining the position of hydroelectric generating device comprises attaching a buoyant float assembly to the positioning device to maintain a vertical orientation of the hydroelectric generating device within the water body.

5. The method of claim 1, wherein engaging the water flow further comprises:
providing a front axle assembly and a continuous loop including the plurality of deformable engagement members, the continuous loop being positioned over the front axle assembly;
inflating the deformable engagement members to capture the water flow when a deployment surface faces upstream; and
deflating the deformable engagement members when the deployment surface faces downstream.

6. The method of claim 5, further comprising:
rotating the front axle assembly by interaction of the continuous loop with the a retention groove on the front axle assembly under the influence of captured water flow by the deformable engagement members to generate the rotational input.

7. The method of claim 6, further comprising:
communicating the rotational input to the generator assembly with a shaft assembly adapted to operably interconnect the front axle assembly with the generator assembly.

8. The method of claim 1, further comprising:
supplying a second axle assembly at a downstream end of the continuous loop to maintain tension on the continuous loop and to prevent tangling of the plurality of deformable engagement members.

9. A hydroelectric generating system, comprising:
a positioning assembly including an anchor assembly on a lower surface of a water body;
a water interface assembly including a front axle assembly and a continuous loop interfacing with a retention groove on the front axle assembly, the continuous loop having a plurality of deformable engagement members adapted to interface with a water flow within the water body; and
a generator assembly having a airtight generator and a transmission line, the generator assembly residing on the lower surface of the water body and wherein a shaft assembly is adapted to transmit rotational energy from the front axle assembly to the airtight generator to generate electricity.

10. The hydroelectric generating system of claim 9, wherein the continuous loop comprises a cable loop and the plurality of deformable engagement members comprise a plurality of parachute assemblies.

11. The hydroelectric generating system of claim 10, wherein the cable loop comprises a segmented cable loop having a plurality of evenly spaced projecting members to engage the retention groove so as to limit slippage of the cable loop and improve energy transfer and overall efficiency.

12. The hydroelectric generating system of claim 10, wherein each of the plurality of parachute assemblies includes a canopy having an upper canopy portion and a lower canopy portion, wherein the upper canopy portion includes an upper float assembly and the lower canopy portion includes a lower sinker assembly to maintain a vertical orientation of each parachute assembly.

13. The hydroelectric generating system of claim 9, wherein the continuous loop comprises a continuous belt and the plurality of deformable engagement members comprise a plurality of collapsible pocket members.

14. The hydroelectric generating system of claim 9, wherein the water interface assembly comprises a second downstream axle assembly to maintain tension on the continuous loop and to prevent tangling of the plurality of deformable engagement members.

15. The hydroelectric generating system of claim 14, wherein the second downstream axle assembly include a positioning parachute.

16. The hydroelectric generating system of claim 9, wherein each of the plurality of deformable engagement members is inflated to capture the water flow when a deployment surface faces upstream and is deflated when the deployment surface faces downstream.

17. A hydroelectric generating system, comprising:
a positioning assembly including an anchor assembly on a lower surface of a water body;
a water interface assembly including a front axle assembly and a continuous cable loop interfacing with a retention groove on the front axle assembly, the continuous cable loop having a plurality of parachute assemblies adapted to interface with a water flow within the water body; and
a generator assembly having a airtight generator and a transmission line, the generator assembly residing on the lower surface of the water body and wherein a shaft assembly is adapted to transmit rotational energy from the front axle assembly to the airtight generator to generate electricity.

18. The hydroelectric generating system of claim 17, wherein each of the plurality of parachute assemblies includes a canopy having an upper canopy portion and a lower canopy portion, wherein the upper canopy portion includes an upper float assembly and the lower canopy portion includes a lower sinker assembly to maintain a vertical orientation of each parachute assembly.

19. The hydroelectric generating system of claim 18, wherein the front axle assembly includes an axle body having a upper tapered surface, an upper retention groove, a lower tapered surface and a lower retention groove, wherein the upper retention groove and the upper tapered surface maintain the upper canopy portion and the lower retention groove and the lower tapered surface maintain the lower canopy portion to prevent tangling of the upper canopy portion and the lower canopy portion.

20. The hydroelectric generating system of claim 17, wherein the continuous cable loop includes a plurality of evenly spaced projecting members and wherein the retention groove comprises a notched retention groove such that physical engagement of the projecting members within the notched retention groove limits slippage of the continuous cable loop and improves energy transfer and overall efficiency.
